(19) United States
(12) Patent Application Publication
(10) Pub. No.: US 2014/0197983 A1
(43) Pub. Date: Jul. 17, 2014

(54) RECEIVER DEVICE, MULTI-FREQUENCY RADAR SYSTEM AND VEHICLE

(71) Applicant: RALF REUTER, MUNICH (DE)

(72) Inventor: RALF REUTER, MUNICH (DE)

(21) Appl. No.: 14/009,009

(22) PCT Filed: Apr. 20, 2011
(86) PCT No.: PCT/IB11/51713

§ 371 Date: Sep. 30, 2013

(51) Int. Cl. G01S 7/02; G01S 13/02

(52) U.S. Cl. CPC G01S 7/02; G01S 13/02
USPC 342/200; 342/175

(57) ABSTRACT

A receiver device for a radar system comprises a receive antenna module arranged to simultaneously receive a plurality of radar signals; a mixer module connected to the antenna module and arranged to simultaneously convert the plurality of radar signals into a plurality of intermediate frequency signals, each of the plurality of intermediate frequency signals having a frequency that is comprised in a different corresponding one of a plurality of intermediate frequency ranges; and a wideband analog-to-digital-converter module connected to the mixer module, arranged to simultaneously convert the plurality of intermediate frequency signals into a digital representation, and having a bandwidth comprising a plurality of non-overlapping bandwidth portions, wherein each of the plurality of intermediate frequency ranges is comprised in a different one of the non-overlapping bandwidth portions.

### FIELD OF THE INVENTION

This invention relates to a receiver module, a multi-frequency radar system and a vehicle.

### BACKGROUND OF THE INVENTION

Radar is an object-detection technology wherein a transmitter or sender emits or radiates electromagnetic waves, specifically radio waves, as radar signals, which are subsequently at least partly reflected by a fixed or moving object. A receiver module of the radar system receives the returned radar signals and, for example, converts them into a digital domain for further evaluation, such as the determination of the current position and speed of a moving object.

In a multiple frequency radar system, the transmitter module transmits signals of multiple frequencies, i.e., electromagnetic waves having frequencies located in different portions or channels of the available frequency band. A receive antenna, which may for example consist of a single antenna or an array of different antennas, receives all channels, and each channel is demodulated and then digitized separately.

In WO 2005/104417, a system for multiple frequency through-the-wall motion detection is shown. A multi-frequency or multi-tone continuous wave (CW) radar is used to project radar signals from the same antenna and to receive returning signals from the same antenna. The phase difference between the outgoing wave and the returns of the two-tone pulses is analyzed to determine both the existence of motion and the distance of the moving object from the antenna.

In P. VAN GENDEREN, P. HAKKAART, J. VAN HEIJENOORT, G. P. HERMANS, “A multi frequency radar for detecting landmines: Design aspects and electrical performance”, 31st European Microwave Conference, 0-86213-148-0, pp. 249-252, London, United Kingdom, 2001, a radar system based on the principle of a Stepped Frequency Continuous Wave (SFCW) transmission scheme is presented. The transmitter transmits eight frequencies at the same time through one antenna and repeats this procedure sixteen times with shifted frequency offsets in order to collect a set of 128 frequency samples. For this, an initial signal is mixed by eight different local oscillator frequencies. Each of the obtained eight signals is treated in its own upmixing tract. On receive, each of the eight signals is converted into a 16 bit digital representation.

### SUMMARY OF THE INVENTION

The present invention provides a receiver module, a multi-frequency radar system and a vehicle as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a first example of an embodiment of a multi-frequency radar system comprising a receiver device.

FIG. 2 schematically shows a diagram of an example of multi-frequency chirps.

FIG. 3 schematically shows a diagram of an example of different intermediate frequency ranges within a bandwidth of an analog-to-digital converter according to an embodiment of a receiver device.

FIG. 4 schematically shows a diagram of an example of a power spectrum of two transmit signals.

FIG. 5 schematically shows a diagram of an example of a power spectrum of two receive signals.

FIG. 6 schematically shows a diagram of an example of a power spectrum of two intermediate frequency signals.

FIG. 7 schematically shows a second example of an embodiment of a multi-frequency radar system comprising a receiver device.

FIG. 8 schematically shows an example of an embodiment of a vehicle comprising a multi-frequency radar system.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary, as illustrated, for the understanding and appreciation of the underlying concepts of the present invention and in order not to obfuscate or distract from the teachings of the present invention.

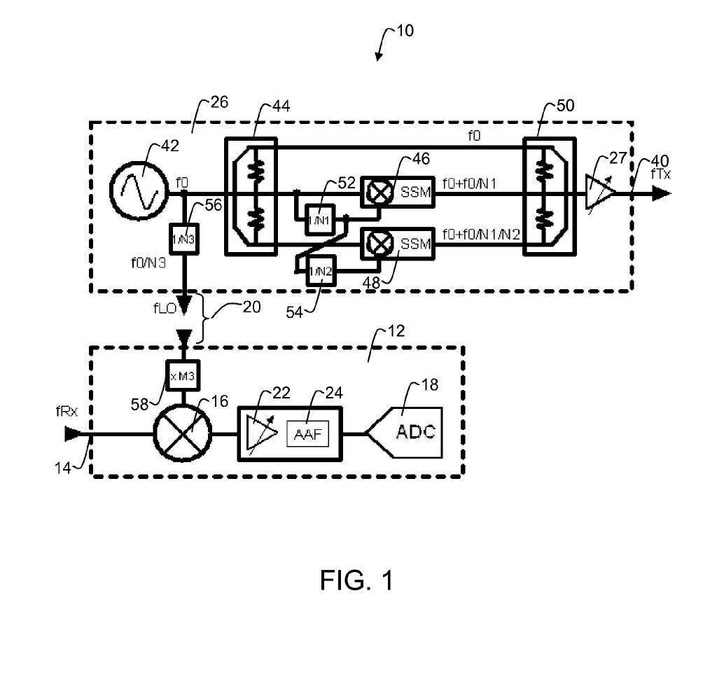

Referring to FIG. 1, a first example of an embodiment of a multi-frequency radar system 10 comprising a receiver device 12 is schematically shown. A receiver device 12 for a radar system 10 comprises a receive antenna module 14 arranged to simultaneously receive a plurality of radar signals (fRx); a mixer module 16 connected to the antenna module 14 and arranged to simultaneously convert the plurality of radar signals into a plurality of intermediate frequency (IF) signals, each of the plurality of intermediate frequency signals having a frequency that is comprised in a different corresponding one of a plurality of intermediate frequency ranges; and a wideband analog-to-digital-converter module 18 (ADC) connected to the mixer module 16, arranged to simultaneously convert the plurality of intermediate frequency signals into a digital representation, and having a bandwidth comprising a plurality of non-overlapping bandwidth portions, wherein each of the plurality of intermediate frequency ranges is comprised in a different one of the non-overlapping bandwidth portions.

A signal may be a change of a physical quantity carrying information, for example an electromagnetic wave. A signal may, for example, be a radio frequency signal or an optical signal.

Receiving a signal may refer to receiving an electromagnetic wave that causes a variation of a physical quantity, such as a voltage change, at the receive antenna module 14.

A receive antenna module 14 may comprise a set of antennas. In an embodiment, a receive antenna module may be a single antenna arranged to receive arranged to simultaneously receive some or all of the returned radar signals.

A radar signal received by a receive antenna module 14 may be an electromagnetic wave radiated by a transmitter device 26 of the radar system 10, at least partly reflected by at least one object and returned to the receiver device 12 of the radar system 10. Frequency bands of radar signals may be in a spectrum of a few Mega-Hertz (MHz), e.g. for coastal radar, up to 77 Giga-Hertz (GHz), 100 GHz or more, for example for use in automotive radar systems.

Simultaneously receiving a plurality of radar signals may refer to receiving a radar signal comprising a mixture of multiple frequencies, i.e., receiving radar signals of multiple frequencies in parallel, at the same time.

A frequency range may be a portion of the frequency spectrum wherein frequency components of the particular signal may occur.

A mixer module 16 may be arranged to mix one or more incoming signals, such as the plurality of radar signals, with one or more modulation signals, in order to shift incoming signal frequencies into output signal frequencies. Output signals may, for example, be referred to as intermediate frequency signals if the signals are downconverted to lower frequency ranges. The mixer module may, for example, be arranged to receive a single local oscillator signal 20 (fLO) for simultaneously converting the plurality of radar signals into the plurality of intermediate frequency signals. The local oscillator signal may be generated by the receiver device 12 itself or may be received through an input terminal. Instead of applying different local oscillator signals for mixing radar signals with different frequencies, the same local oscillator signal may be applied simultaneously to all the received radar signals for downconversion to different intermediate frequency ranges. The mixer module 16 may, for example, be a single-sideband modulation module. In another embodiment, depending on the modulation chosen in the transmitter device 26, mixing may be performed using, for example, double-sideband modulation or IQ modulation.

An analog-to-digital converter (ADC) module may refer to one or more parallel ADC. In an embodiment of the receiver device, a wideband ADC module 18 may be a single device or circuit for conversion of more than one or all intermediate frequency signals. This may, for example, reduce required die area, power consumption and hardware costs.

An ADC may be arranged to convert a continuous quantity, such as the plurality of intermediate frequency signals, into a discrete time digital representation. A wideband ADC 18 may be an ADC having a bandwidth greater than the bandwidth required for receiving a single signal of a typical single frequency range. Bandwidth of an ADC may describe the frequency range in which an input signal may pass through an analog front end of the ADC with minimal amplitude loss. For example, bandwidth may be specified by the frequency at which a sinusoidal input signal is attenuated to 70.7% of its original amplitude, i.e., the −3 Decibel (dB) point. As an example, the wideband ADC module 18 may have a bandwidth of 10 MHz or 20 MHz, compared to standard ADC with, for example, about 1 MHz bandwidth. If, for example, the frequency ranges of the intermediate frequency signals are spaced in 500 kHz portions, a 10 MHz wideband ADC may be used for analog-to-digital conversion of up to 20 intermediate frequency signals simultaneously, i.e., at the same time.

The ADC module 18 may, for example, receive the intermediate frequency signals amplified by an amplifier circuit 22. And the intermediate frequency signals may be filtered by an anti-aliasing filter 24 (AAF) before provision to the wideband ADC module 18.

The shown receiver device 12 for a radar system 10 may, for example, instead of providing multiple receive channels for multiple received signals, provide only one channel for reception and conversion of received radar signals. Instead of implementing multiple receive channels using a time multiplexing approach, the IF-to-digital conversion can be done simultaneously, i.e. in parallel, which may increase the system update rate, while avoiding costs for providing multiple hardware connected in parallel for parallel processing of simultaneously incoming radar signals.

The system update rate may be the amount of updates of distance or speed information calculated by an evaluation unit (not shown) connected to the ADC and arranged to evaluate the digital output of the ADC. If, for example, 512 measured values are required for a obtaining a result having an acceptable signal-to-noise-ratio, and eight different radar signals are used, the shown efficient solution using a wideband ADC, which may, for example, be arranged to process the eight received signals in parallel, the system update rate may be eight times increased compared to a time multiplex solution. A one-channel receiver device with a wideband ADC module 18 may be applied when the bandwidth of the ADC module 18 is larger than the difference between the upper limit of the highest frequency range and the unchanged local oscillator radar frequency f0.

As shown in FIG. 1, a multi-frequency radar system 10 may comprise a receiver device 12 as described above and a transmitter device 26 arranged to simultaneously provide a plurality of radar signals having different radar frequencies.

The term different radar frequencies may refer to the frequencies of signals simultaneously radiated by the transmitter device 26, or received by the receiver device 12 at the same point of time. Apart from that, a radar signal may have a constant or a variable frequency over time. For example, the plurality of radar signals fTx radiated by the transmitter may be a plurality of different chirp signals. A chirp signal or sweep signal is a signal in which the frequency increases or decreases with time, within a period T. In a linear chirp, the frequency may vary linearly with time, resulting in a frequency ramp or up-chirp, or in a triangular chirp (up-chirp and subsequent down-chirp).

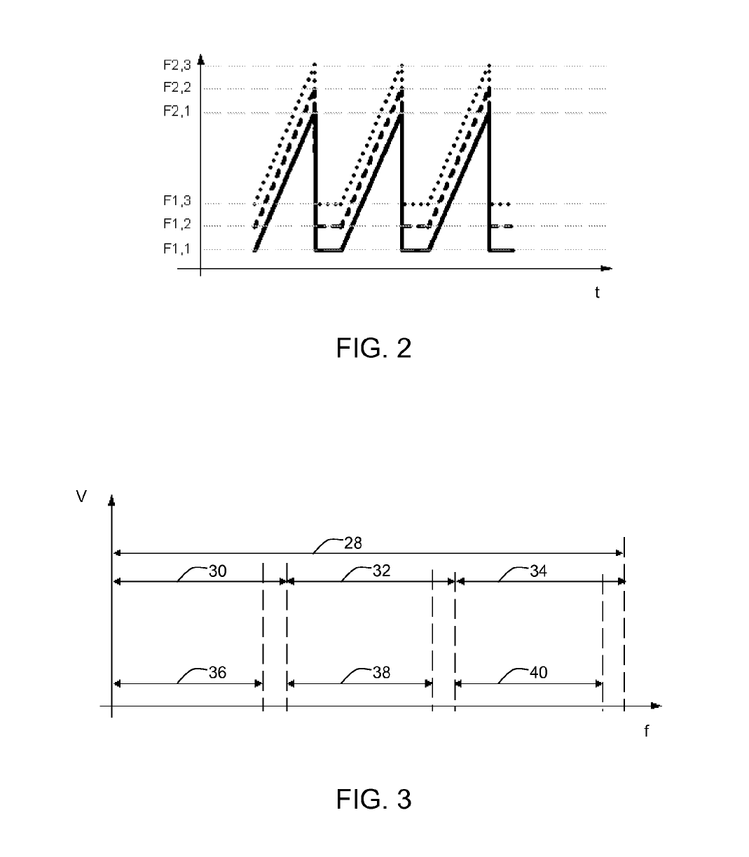

Referring to FIG. 2, a diagram of an example of multi-frequency chirps is shown, where multiple frequency signals are transmitted via one antenna. Transmit Tx frequencies for three radar signals linearly vary over time t between F1,1 and F2,1; F1,2 and F2,2, indicated by a dashed line; and F1,3 and F2,3, indicated by a dotted line. At each point of time, the current frequencies of the three chirp signals may be different from each other.

Chirp signals may, for example, be used for the multi-frequency radar system shown in FIG. 1, e.g., when the multi-frequency radar system is a frequency modulated continuous-wave (FMCW) radar system. For FMCW radar, the continuous wave energy is modulated by a ramp signal or triangular modulation signal. FMCW radar may be used, for example, when both distance and velocity of an object are to be measured. Other radar signals may be used, for example continuous wave (CW) radar, where electromagnetic waves of constant amplitude and frequency are used. Or the radar signals radiated by the transmitter module may, for example, be frequency-shift-keying (FSK) signals, i.e. signals, which comprise different frequencies constant over a certain period of time, e.g., generated by switching between a selected amount of frequencies. Other frequency modulation techniques may be used additionally or instead.

Referring to FIG. 3, a diagram of an example of different intermediate frequency ranges within a bandwidth of an analog-to-digital converter according to an embodiment of a receiver module is schematically shown. For the example shown in FIG. 2, wherein IF voltage V is shown over frequency range f, the shown ADC bandwidth 28 may comprise three non-overlapping bandwidth portions 30, 32, 34; and the three intermediate frequency ranges 36, 38, 40 corresponding to the radar signal frequencies may be comprised in different bandwidth portions 30, 32, 34. The first IF range 36 for F1,1 up to F2,1 may be comprised in frequency portion 30, the second IF range 38 for F1,2 up to F2,2 may be comprised in frequency portion 32, and the third IF range 40 for F1,3 up to F2,3 may be comprised in frequency portion 34.

ADC bandwidth portions 30, 32, 34 may be selected according to the expected transmit frequency ranges. For the first embodiment of the radar system 10 shown in FIG. 1, ADC bandwidth portions may be selected f0, f0+f0/N1/N2 and f0+f0/N1, as explained below.

Referring again to FIG. 1, the transmitter device 26 of the multi-frequency radar system 10 may comprise a transmit antenna module 40; a signal generation module 42 arranged to provide a local oscillator radar signal (f0) having a local oscillator frequency; a power divider module 44 connected to receive and arranged to split the local oscillator radar signal into a plurality of splitted radar signals; one or more modulator modules 46, 48, each connected to receive a corresponding one of the splitted radar signals and provide a different corresponding frequency modulated radar signal (f0+f0/N1, f0+f0/N1/N2); a power combiner module 50 connected to receive and provide simultaneously the one or more frequency modulated radar signals and one of the plurality of splitted radar signals (f0) to the transmit antenna module 40. This may allow to simultaneously radiate transmit radar signals of multiple frequencies (fTx), which may be reflected by an object and be received as received radar signals (fRx) by the receiver device 12 for further simultaneous processing. The shown radar system comprising the transmitter device 26 and the receiver device 12 may provide an increased resolution by an increase of the system update rate.

The shown transmitter may, for example, be implemented on a single chip and the transmit antenna module 40 may, for example, comprise a single transmit antenna.

Depending on the implemented radar system, the signal generation module 42 may be arranged to provide a local oscillator radar signal having a constant frequency over time or a chirp signal with changing frequency over time, e.g., for FMCW radar, or any other signal.

The power divider module 44 and the power combiner module 50 may, for example, be implemented using passive components such as a Wilkinson Power Divider or Wilkinson Power Combiner, respectively. Other active or passive power dividers or directional couplers may be used additionally or instead.

The radar signals may be amplified using an amplifier 27 before provision to the transmit antenna module 40.

As shown in FIG. 1, the multi-frequency radar system 10 may comprise one or more frequency divider modules 52, 54, at least some of which arranged to provide a different modulation signal generated by frequency division of the splitted radar signal, to corresponding ones of the one or more modulator modules 46, 48. The shown embodiment of a transmitter module for a radar system may allow to generate the modulation signals for the modulator modules 46, 48 without providing additional local oscillators for provision of different modulation signals. As shown, the modulation signals may be generated directly from the local oscillator radar signal (f0) by division with a constant factor, for example N1 and N1/N2, respectively. This may result in frequency modulated splitted local oscillator signals f0+f0/N1 and f0+f0/N1/N2. The shown provision of modulation signals may allow for non-overlapping frequency ranges. Other local oscillator distribution schemes for generating the modulation signals from the local oscillator radar signal may be used instead. For example, the two frequencies may be generated differently from up converting (f0+f0/N1/N2 and f0+f0/N1). One could, for example, be generated by up-converting (f0+f0/N1) and the other by down-converting (f040/N1). They may then be spaced equally around the first frequency.

For linear chirp signals as shown in FIG. 2, each of the signals provided to the power combiner module 50 may comprise a different frequency ramp with an identical gradient.

The one or more modulator modules 46, 48 may, for example, be single-sideband modulation modules. In this case, the mixer module of the receiver device 12 may, for example, be selected as double-sideband modulation modules. Other receiver-side mixer modules, such as IQ mixers or single-sideband mixers may be used instead. In another embodiment, the transmitter-side modulation modules 46, 48 may be selected as double-sideband modulation modules.

In order to provide identical local oscillator signals to the transmitter device 26 and the receiver device 12 without providing more than one signal generation module 42, the multi-frequency radar system 10 may comprise a path, such as a connecting line, between the transmitter device 26 and the receiver device 12, wherein the mixer module 16 of the receiver device 12 may be connected to the signal generation module 42 of the transmitter device 26. The path may be a single connecting line.

A path for connecting the mixer module 16 of the receiver device 12 and the signal generation module 42 of the transmitter device 26 may, for example, comprise a further frequency divider module 56 and a frequency multiplier module 58. The further frequency divider module 56 may apply a frequency division by a factor N3, which may at least partly be compensated by frequency multiplier 58, which may apply a frequency multiplication by a factor M3. For example, M3 may be chosen equal to N3. This may allow to transfer the generated signal at a lower frequency where less attenuation and distortion of the signal may be encountered, and to restore the signal with identical frequency for demodulation mixing. For example, an automotive radar signal of 77 GHz may be transmitted from the transmitter to the receiver as a 38.5 GHz signal and restored at the receiver-side as a 77 GHz signal.

The presented multi-frequency radar system 10 may allow to simplify and reduce hardware requirements, e.g., by using only one receive channel, one mixer, one local oscillator signal and one wideband ADC 18 for converting IF signals from multiple beams. Multiplexing of IF signals may be avoided and system errors concerning the measured velocity and distance may be reduced, while at the same time overall power consumption of the system may be reduced. For further reduction of hardware constraints, the transmit antenna module 40 and the receiver antenna module 14 may, for example, be the same antenna module, i.e., only one antenna may be used for radiation and reception of radar signals.

In an embodiment of the radar system 10, the system may be applied to dedicated antennas of phased array systems.

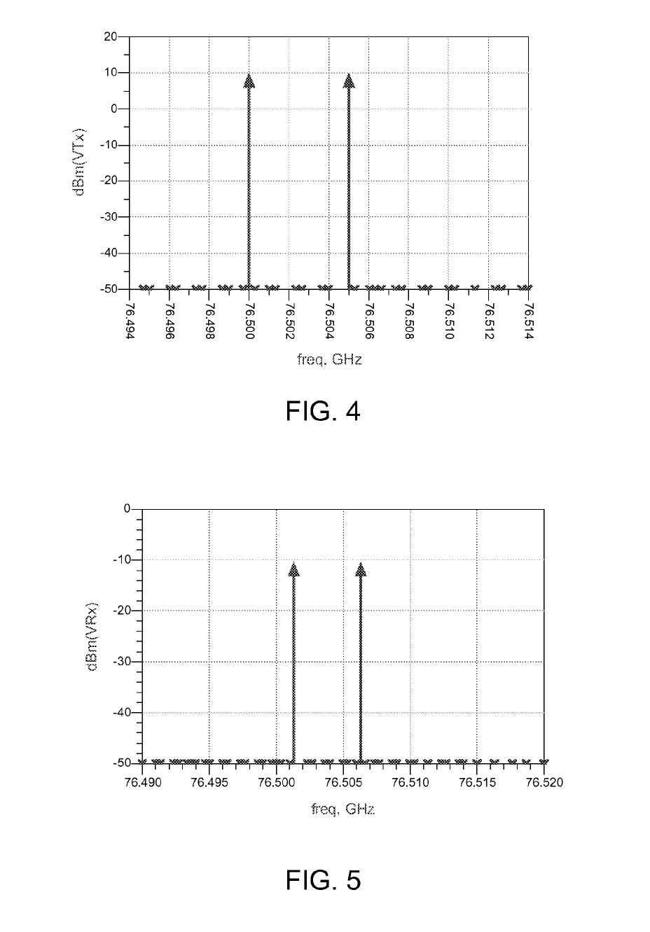

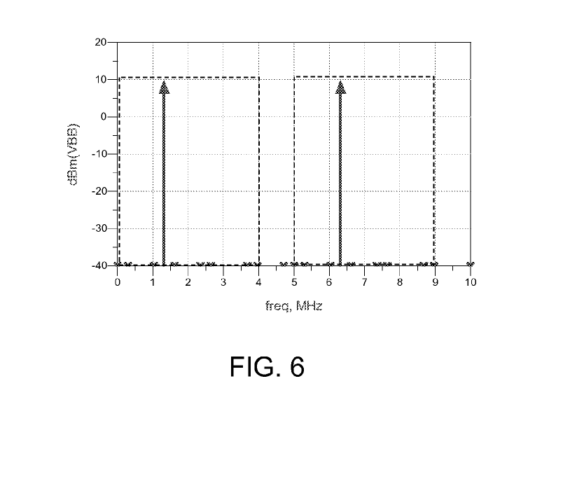

An example for frequency shifting of signals in a system with two tones, i.e., two radar signals of different frequencies is given by FIGS. 4, 5, and 6. Referring to FIG. 4, a diagram of an example of a power spectrum of two transmit signals is schematically shown. The diagram schematically shows a power ratio measured in terms of voltage at the transmit antenna module (VTx) in dBm, i.e. the power ratio in decibels (dB) of the measured power referenced to one milliwatt over frequency freq (measured in GHz) of the frequency of radiated transmit radar signals. The first signal or tone may, for example, have a frequency of 76.5 GHz and may, for example, be received as a splitted local oscillator signal from the signal generation module 42. The frequency of the second signal or tone may, for example, differ from the first one by 5 MHz. Referring to FIG. 5, a diagram of an example of a power spectrum of two simultaneously received radar signals is schematically shown. The diagram schematically shows a power ratio measured in terms of voltage at the receive antenna module (VRx) in dBm over frequency freq (measured in GHz) of the frequency of the received radar signals. It can be seen that only a portion of the transmitted signal power may be received. Due to time delay caused by the radiation and reflection of the radar signals, signals may be frequency shifted, e.g., by 1.3 MHz. Referring to FIG. 6, a diagram of an example of a power spectrum of two intermediate frequency signals is schematically shown. The diagram schematically shows a power ratio measured in terms of voltage measured at the mixer module output (VBB) in dBm over frequency freq (measured in MHz) of the frequency of the intermediate frequency signals. After a frequency shift by oscillator frequency 76.5 GHz, the intermediate frequencies may now be detected at 1.3 and 6.3 MHz, each signal shown in its corresponding frequency range 0 to 4 MHz and 5 to 9 MHz, respectively, indicated by the dashed boxes, just to give an example. These signals may be fed to into the wideband ADC for conversion into the digital domain and further analysis. The shown frequency difference of 5 MHz may be used for calculation of the distance of the detected object. For the shown example, the object may not be a moving object. Otherwise, Doppler frequencies may be encountered in the spectrum, which may be used for calculating the velocity of the object.

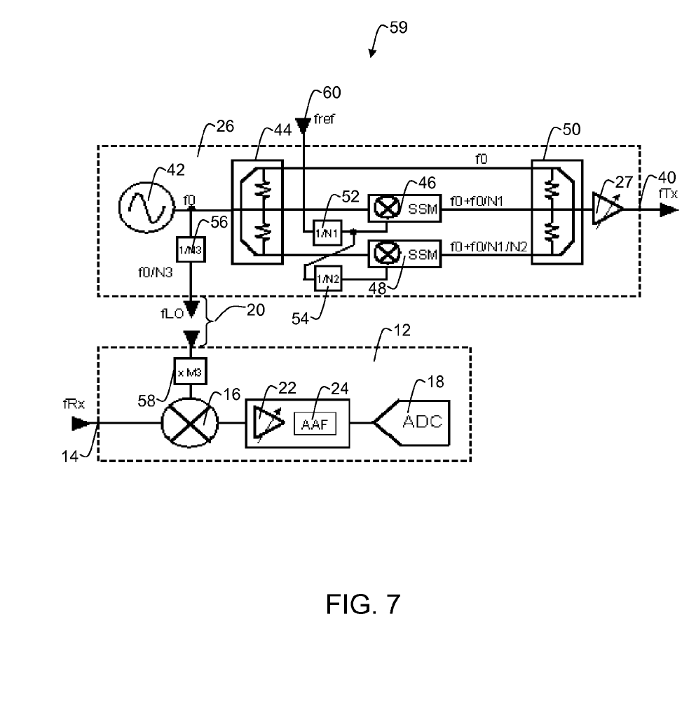

Referring now to FIG. 7, a second example of an embodiment of a multi-frequency radar system 59 comprising a receiver device 12 is schematically shown. The structure of the shown second embodiment 59 is similar to the first embodiment shown in FIG. 1 and only elements differing from the radar system shown in FIG. 1 will be described. The system is identical to the system of FIG. 1, except the generation of the modulation signals applied to the modulator modules 46, 48. The shown multi-frequency radar system may comprise one or more frequency divider modules 52, 54, at least some of which arranged to provide a different modulation signal generated by frequency division of a reference signal 60 having a constant reference frequency, to a corresponding one of the one or more modulator modules 46, 48. With this constant frequency offset instead of a frequency offset following any change of the frequency provided by the signal generation module, as shown in FIG. 1, more information, especially when tracking more than one object, may be derived from the received radar signals. In case of a FMCW radar system, the gradients of the frequency ramps may not be identical for each of the multi-frequency chirps, but may depend on the reference frequency fref and the frequency division factors N1, N2 of frequency divider modules 52, 54.

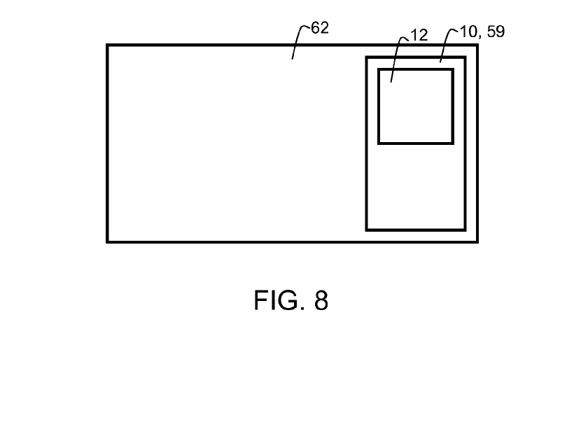

Referring now to FIG. 8, an example of an embodiment of a vehicle comprising a multi-frequency radar system is schematically shown. As shown, a vehicle 62 may comprise a receiver device 12 or a multi-frequency radar system 10, 59 as described above. The radar system 10, 59 may be implemented based on, for example, a 77 GHz radar chipset. The radar system 10, 59 may, for example, be an automotive radar system. Radar technology may for example be used for road safety applications such as Adaptive Cruise Control (ACC) long-range radar, which may, for example, operate at 77 GHz. This may enable a vehicle to maintain a cruising distance from a vehicle in front. As another example, radar may also be used for anti-collision ‘short-range radar’ operating, for example, in a range of 24 GHz, 26 GHz or 79 GHz. Here it may be part of a system for warning a driver of a pending collision, enabling avoiding action to be taken. In the event where collision is inevitable, the vehicle may prepare itself, for example, by applying brakes, pre-tensioning seat belts etc., for reducing injury to passengers and others. It should be noted that the presented system may be applied to applications using any other frequency range, for example other mm-wave applications, e.g. working at 122 GHz or using a wireless personal area network (WPAN) communication applications, for example working at 60 GHz and employing IEEE 802.15 standard, car2car ad-hoc networks, just to name a few.

A vehicle 62 may be a car. Or it may be any automotive apparatus, such as a train, a plane, a ship, a helicopter, a bike etc. For example, the shown radar system may be used to provide a better resolution and update rate when measuring the exact height of a plane during landing procedure.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the transmitter device 26 and the receiver device 12 may be implemented as a single device.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. For example, the transmitter device 26 may be implemented on a single integrated circuit. Alternatively, the examples may be implemented as any number of separate integrated circuits or separate devices interconnected with each other in a suitable manner. For example, the signal generation module 42 may be implemented separately from the rest of the transmitter device 26.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While the principles of the invention have been described above in connection with specific apparatus, it is to be clearly understood that this description is made only by way of example and not as a limitation on the scope of the invention

1. A receiver device for a radar system, comprising
a receive antenna module arranged to simultaneously receive a plurality of radar signals;
a mixer module connected to said antenna module and arranged to simultaneously convert said plurality of radar signals into a plurality of intermediate frequency signals, each of said plurality of intermediate frequency signals having a frequency that is comprised in a different corresponding one of a plurality of intermediate frequency ranges; and
a wideband analog-to-digital-converter module connected to said mixer module, arranged to simultaneously convert said plurality of intermediate frequency signals into a digital representation, and having a bandwidth comprising a plurality of non-overlapping bandwidth portions, wherein each of said plurality of intermediate frequency ranges is comprised in a different one of said non-overlapping bandwidth portions.

2. The receiver device as claimed in claim 1, wherein said mixer module is arranged to receive a single local oscillator signal for simultaneously converting said plurality of radar signals into said plurality of intermediate frequency signals.

3. The receiver device as claimed in claim 1, wherein said mixer module is a single-sideband modulation module.

4. A multi-frequency radar system, comprising
a transmitter device arranged to simultaneously provide a plurality of radar signals having different radar frequencies; and
a receiver device as claimed in claim 1.

5. The multi-frequency radar system as claimed in claim 4, wherein said plurality of radar signals is a plurality of different chirp signals.

6. The multi-frequency radar system as claimed in claim 4, wherein said multi-frequency radar system is a frequency modulated continuous-wave radar system.

7. The multi-frequency radar system as claimed in claim 4, wherein said transmitter device comprises
a transmit antenna module;
a signal generation module arranged to provide a local oscillator radar signal having a local oscillator frequency;
a power divider module connected to receive and arranged to split said local oscillator radar signal into a plurality of splitted radar signals;
one or more modulator modules, each connected to receive a corresponding one of said splitted radar signals and provide a different corresponding frequency modulated radar signal;
a power combiner module connected to receive and provide simultaneously said one or more frequency modulated radar signals and one of said plurality of splitted radar signals to said transmit antenna module.

8. The multi-frequency radar system as claimed in claim 7, comprising one or more frequency divider modules, at least some of which arranged to provide a different modulation signal generated by frequency division of said splitted radar signal, to corresponding ones of said one or more modulator modules.

9. The multi-frequency radar system as claimed in claim 7, wherein said one or more modulator modules are single-sideband modulation modules.

10. The multi-frequency radar system as claimed in claim 7, wherein said mixer module of said receiver device is connected to said signal generation module of said transmitter device.

11. The multi-frequency radar system as claimed in claim 10, wherein a path for connecting said mixer module of said receiver device and said signal generation module of said transmitter device comprises a further frequency divider module and a frequency multiplier module.

12. The multi-frequency radar system as claimed in claim 7, wherein said transmit antenna module and said receiver antenna module are the same antenna module.

13. The multi-frequency radar system as claimed in claim 7, comprising one or more frequency divider modules, at least some of which arranged to provide a different modulation signal generated by frequency division of a reference signal having a constant reference frequency, to a corresponding one of said one or more modulator modules.

14. A vehicle, comprising a receiver device as claimed in claim 1.
